(19) United States
(12) Patent Application Publication
(10) Pub. No.: US 2026/0098613 A1
(43) Pub. Date: Apr. 9, 2026

(54) CRYOGENIC LIQUID STORAGE APPARATUS

(71) Applicants: Hyundai Motor Company, Seoul (KR); Kia Corporation, Seoul (KR)

(72) Inventors: Hai Jun Jeong, Hwaseong-Si (KR); Jin Young Heo, Hwaseong-Si (KR)

(73) Assignees: Hyundai Motor Company, Seoul (KR); Kia Corporation, Seoul (KR)

(21) Appl. No.: 19/186,235

(22) Filed: Apr. 22, 2025

(30) Foreign Application Priority Data
Oct. 8, 2024 (KR) 10-2024-0137130

(51) Int. Cl. F17C 13/00

(52) U.S. Cl. CPC F17C 13/001; F17C 2201/0109; F17C 2223/0161; F17C 2270/01

(57) ABSTRACT

A cryogenic liquid storage apparatus includes an internal container, in which a cryogenic liquid is accommodated, an external container that surrounds a circumference of the internal container, an external suspension portion connected to an internal surface of the external container, an internal suspension portion connected to the internal container, and a connection suspension portion continuously connecting the external suspension portion and the internal suspension portion and defining a transfer path of heat transferred from the external container to the internal container. Accordingly, an insulation performance may be secured and safety and reliability may be improved.

### CROSS-REFERENCE TO RELATED APPLICATION

The present application claims priority to Korean Patent Application No. 10-2024-0137130, filed in the Korean Intellectual Property Office on Oct. 8, 2024, the entire contents of which is incorporated herein for all purposes by this reference.

### BACKGROUND OF THE PRESENT DISCLOSURE

### Field of the Present Disclosure

The present disclosure relates to a cryogenic liquid storage apparatus, and more particularly, to a cryogenic liquid storage apparatus which may secure an insulation performance and improve safety and reliability.

### Description of Related Art

A fuel cell system is a system that produces electrical energy through an oxidation/reduction reaction of hydrogen and oxygen, and continuous studies and developments are being made as a way to solve a global environment problem.

In recent years, to increase an energy storage density per unit volume of a fuel (for example, hydrogen) used in the fuel cell system, various tries for keeping hydrogen in a storage container in a cryogenic (for example, 20 K to 33 K) liquid state (liquid hydrogen) and supplying hydrogen (liquid or gaseous hydrogen) stored in the storage container to a fuel cell stack have been made.

In general, the storage container may include an internal container, in which a cryogenic liquid is accommodated, and an external container which is formed to surround a circumference of the internal container, and a suspension member for supporting the internal container against the external container may be disposed between the internal container and the external container.

Meanwhile, to increase a storage efficiency of a cryogenic fluid and ensure safety and reliability, a rise in the pressure of the cryogenic fluid due to heat introduced from an outside of the external container to the internal container has to be minimized.

However, conventionally, unnecessary heat is transferred to the internal container (cryogenic liquid) via a suspension member that support the internal container against the external container

When the heat of the external container is transferred (conducted) to the internal container through the suspension member, an amount of hydrogen (discarded lost hydrogen) which is discharged from the internal container increases as the pressure of hydrogen increases (a pressure due to gasification of liquid hydrogen increases), and a non-loss hydrogen keeping period (dormancy) (a period, for which hydrogen is not discharged from the storage container and is kept) is shortened.

Accordingly, various studies have recently been conducted to secure an insulation performance and improve safety and reliability, but it is still insufficient, and development for them is required.

### BRIEF SUMMARY

The present disclosure has been made to solve the above-mentioned problems occurring in the related art while advantages achieved by the related art are maintained intact.

Various aspects of the present disclosure are directed to providing a cryogenic liquid storage apparatus which may secure an insulation performance and improve safety and reliability.

In an exemplary embodiment of the present disclosure, heat which is conducted to an internal container (storage container) via a suspension portion that supports the internal container against an external container may be minimized and an insulation performance of the internal container may be secured.

Most of all, according to an exemplary embodiment of the present disclosure, the heat transferred (conducted) from the external container to the internal container may be minimized by sufficiently securing the transfer path of the heat transferred along the suspension portion while securing the structural stability by the suspension portion.

Furthermore, according to an exemplary embodiment of the present disclosure, loss (an amount of discharged hydrogen) of hydrogen may be minimized while durability and safety are secured, and a time point, at which the hydrogen starts to be lost, may be maximally delayed (a non-loss hydrogen keeping period is extended).

Furthermore, according to an exemplary embodiment of the present disclosure, an excessive pressure rise (expansion) of the storage container may be restrained, and safety and reliability may be improved.

The problems to be solved in the exemplary embodiments are not limited thereto, and purposes and effects which may be recognized from the means and the exemplary embodiment forms for solving the problems, which are described below, may be included in the problems to be solved.

According to an aspect of the present disclosure, a cryogenic liquid storage apparatus includes an internal container, in which a cryogenic liquid is accommodated, an external container that surrounds a circumference of the internal container, an external suspension portion connected to an internal surface of the external container, an internal suspension portion connected to the internal container, and a connection suspension portion continuously connecting the external suspension portion and the internal suspension portion and defining a transfer path of heat transferred from the external container to the internal container.

This is to secure an insulation performance of the storage container, and to improve safety and reliability.

That is, to increase a storage efficiency of a cryogenic fluid and ensure safety and reliability, a rise in the pressure of the cryogenic fluid due to heat introduced from an outside of the external container to the internal container has to be minimized.

However, conventionally, unnecessary heat is transferred to the internal container via a suspension member that support the internal container against the external container. Conventionally, when the heat of the external container is transferred (conducted) to the internal container through the suspension member, an amount of hydrogen (discarded lost hydrogen) which is discharged from the internal container increases as the pressure of hydrogen increases (a pressure due to vaporization of liquid hydrogen increases), and a non-loss hydrogen keeping period (dormancy) (a period, for which hydrogen is not discharged from the storage container and is kept) is shortened.

However, because the transfer path of the heat transferred from the external container to the internal container may be sufficiently secured (extended) by connecting the external suspension portion and the internal suspension portion via the connection suspension portion, the heat conducted to the internal container (storage container) via the external suspension portion and the internal suspension portion that support the internal container against the external container may be minimized, and the insulation performance of the internal container may be secured.

Most of all, according to an exemplary embodiment of the present disclosure, the heat transferred (conducted) from the external container to the internal container may be minimized by sufficiently securing the transfer path of the heat transferred along the suspension portion while securing the structural stability by the suspension portion.

Accordingly, because an unnecessary temperature rise and an excessive vaporization of the cryogenic liquid (liquid hydrogen) due to introduction (conduction) of the heat from the external container to the internal container may be restrained, an amount of hydrogen (discarded lost hydrogen) discharged from the internal container may be minimized while an excessive pressure increase of the internal container is restrained, and a time point, at which the hydrogen starts to lost, may be maximally delayed (a non-loss hydrogen keeping period is extended).

The external suspension portion and the internal suspension portion may have various structures according to required conditions and design specifications.

According to an exemplary embodiment of the present disclosure, the internal suspension portion may surround a circumference of the external suspension portion, and one end portion of the external suspension portion may be supported by the external container, and an opposite end portion of the external suspension portion may be disposed as a free end portion in an interior of the internal suspension portion.

The connection suspension portion may have various structures which may connect the external suspension portion and the internal suspension portion.

According to an exemplary embodiment of the present disclosure, the connection suspension portion may include a first pipeline member that includes a cross-sectional area being greater than a cross-sectional area of the external suspension portion, one end portion of which is connected to the opposite end portion of the external suspension portion, and an opposite end portion of which is connected to the internal suspension portion, and the transfer path of the heat may be continuously defined along the external suspension portion and the first pipeline member.

The connection structure of the external suspension portion and the first pipeline member may be variously changed according to required conditions and design specifications.

According to an exemplary embodiment of the present disclosure, the cryogenic liquid storage apparatus may further include a first connection flange disposed at the opposite end portion of the external suspension portion, and that supports one end portion of the first pipeline member with respect to the external suspension portion.

According to an exemplary embodiment of the present disclosure, the connection suspension portion may further include a second pipeline member that includes a cross-sectional area which is greater than that of the first pipeline member, and one end portion of which is connected to the opposite end portion of the first pipeline member, and a third pipeline member that has a cross-sectional area which is greater than that of the second pipeline member, one end portion of which is connected to an opposite end portion of the second pipeline member, and an opposite end portion of which is connected to the internal suspension portion, and the transfer path HP1 of the heat transferred from the external container to the internal container may be defined in a continuous zig-zag shape along the external suspension portion, the first pipeline member, the second pipeline member, and the third pipeline member.

The connection structure of the first pipeline member and the second pipeline member, the connection structure of the second pipeline member and the third pipeline member, and the connection structure of the third pipeline member and the internal suspension portion may be variously changed according to required conditions and design specifications.

According to an exemplary embodiment of the present disclosure, the cryogenic liquid storage apparatus may further include a second connection flange disposed at the opposite end portion of the first pipeline member, and that supports the one end portion of the second pipeline member with respect to the first pipeline member, a third connection flange disposed at the opposite end portion of the second pipeline member, and that supports the one end portion of the third pipeline member with respect to the second pipeline member, and a fourth connection flange disposed at the opposite end portion of the third pipeline member, and connecting the third pipeline member and the internal suspension portion.

According to an exemplary embodiment of the present disclosure, the external suspension portion, the first pipeline member, the second pipeline member, and the third pipeline member may have the same thickness (cross-sectional area).

According to another exemplary embodiment of the present disclosure, the external suspension portion, the first pipeline member, the second pipeline member, and the third pipeline member may have different thicknesses (cross-sectional areas).

According to an exemplary embodiment of the present disclosure, the first pipeline member may have a thickness being smaller than a thickness of the external suspension portion. The second pipeline member may have a thickness being smaller than a thickness of the first pipeline member, and the third pipeline member may have a thickness being smaller than a thickness of the second pipeline member.

This is caused due to an aspect that an amount of heat which is introduced (conducted) along the pipeline members becomes smaller but the yield strength becomes higher as the thicknesses (cross-sectional areas) of the pipeline members become thinner, and according to an exemplary embodiment of the present disclosure, the heat transferred from the external container to the internal container along the connection suspension portion may be minimized while the structural strength of the connection suspension portion is secured as the thicknesses of the external suspension portion, the first pipeline member, the second pipeline member, and the third pipeline member are sequentially smaller in their sequences.

According to an exemplary embodiment of the present disclosure, the cryogenic liquid storage apparatus may further include an insulation member interposed between the external suspension portion and the first pipeline member, between the first pipeline member and the second pipeline member, or between the second pipeline member and the third pipeline member.

In the present way, by providing the insulation members between the external suspension portion and the first pipeline member, between the first pipeline member and the second pipeline member, and the second pipeline member and the third pipeline member, transfer of heat between adjacent pipeline members (or external suspension parts) is minimized, and thus, transfer of the heat of a relatively high temperature portion (for example, the external suspension part) to a low temperature portion (for example, the first pipeline member) disposed on a downstream side (a downstream side along a transfer direction of the heat) of the high temperature portion through a side surface of the high temperature portion may be minimized.

According to an exemplary embodiment of the present disclosure, the connection suspension portion may include a first pipeline member that has a cross-sectional area being smaller than a cross-sectional area of the external suspension portion, disposed in an interior of the external suspension portion, one end portion of which is connected to the opposite end portion of the external suspension portion, and an opposite end portion of which is connected to the internal suspension portion, and the transfer path of the heat may be continuously defined along the external suspension portion and the first pipeline member.

According to an exemplary embodiment of the present disclosure, the first pipeline member may have a thickness being greater than a thickness of the external suspension portion.

This is caused by an aspect that a thermal conductivity tends to increase as it goes to a high temperature portion in heat transfer, and the heat transferred from the external container to the internal container along the connection suspension portion may be further reduced as the high temperature portion (the external suspension part) connected to the external container has a relatively small thickness (cross-sectional area) (that is, as the first pipeline member has a thickness which is greater than that of the external suspension part).

According to an exemplary embodiment of the present disclosure, the connection suspension portion may further include a second pipeline member which is disposed in an interior of the first pipeline member to have a cross-sectional area which is smaller than that of the first pipeline member, and one end portion of which is connected to the opposite end portion of the first pipeline member, and a third pipeline member which is disposed between the external suspension portion and the internal suspension portion to have a cross-sectional area which is greater than that of the external suspension portion, one end portion of which is connected to an opposite end portion of the second pipeline member, and an opposite end portion of which is connected to the internal suspension portion, and the transfer path of the heat transferred from the external container to the internal container may be defined in a continuous zig-zag shape along the external suspension portion, the first pipeline member, the second pipeline member, and the third pipeline member.

According to an exemplary embodiment of the present disclosure, the cryogenic liquid storage apparatus may further include a first connection flange disposed at the opposite end portion of the external suspension portion, and that supports one end portion of the first pipeline member with respect to the external suspension portion.

According to an exemplary embodiment of the present disclosure, the cryogenic liquid storage apparatus may further include a second connection flange disposed at the opposite end portion of the first pipeline member, and that supports the one end portion of the second pipeline member with respect to the first pipeline member, a third connection flange disposed at the opposite end portion of the second pipeline member, and that supports the one end portion of the third pipeline member with respect to the second pipeline member, and a fourth connection flange disposed at the opposite end portion of the third pipeline member, and connecting the third pipeline member and the internal suspension portion.

According to an exemplary embodiment of the present disclosure, the second pipeline member and the third pipeline member may have thicknesses being the same as or different from a thickness of the first pipeline member.

According to an exemplary embodiment of the present disclosure, an insulation member may be disposed between the external suspension portion and the first pipeline member, between the first pipeline member and the second pipeline member, or between the second pipeline member and the third pipeline member.

### BRIEF DESCRIPTION OF THE DRAWINGS

The above and other objects, features and advantages of the present disclosure will be more apparent from the following detailed description taken in conjunction with the accompanying drawings:

FIG. 1 is a view exemplarily illustrating a cryogenic liquid storage apparatus according to an exemplary embodiment of the present disclosure;

FIG. 2 illustrates a cryogenic liquid storage apparatus according to an exemplary embodiment of the present disclosure, and is a view exemplarily illustrating a connection suspension portion;

FIG. 3 illustrates a cryogenic liquid storage apparatus according to an exemplary embodiment of the present disclosure, and is a view exemplarily illustrating a connection flange;

FIG. 4 illustrates a cryogenic liquid storage apparatus according to an exemplary embodiment of the present disclosure, and is a view exemplarily illustrating an insulation member; and

FIG. 5 and FIG. 6 illustrate a cryogenic liquid storage apparatus according to an exemplary embodiment of the present disclosure, and is a view exemplarily illustrating another exemplary embodiment of the connection suspension portion.

### DETAILED DESCRIPTION

Hereinafter, various exemplary embodiments of the present disclosure will be described in detail with reference to the accompanying drawings.

However, the technical spirit of the present disclosure is not limited various exemplary embodiments of the present disclosure, and may be implemented in various different forms, and one or more of the components of the exemplary embodiments may be selectively coupled to each other or replaced with each other to be used without departing from the technical spirit of the present disclosure.

Furthermore, the terms (including technical and scientific terms) used in the exemplary embodiments of the present disclosure may be construed as meanings that may be generally understood to those skilled in the art, to which the present disclosure pertains, unless particularly defined and described clearly.

Furthermore, the terms used in the exemplary embodiments of the present disclosure are disposed to describe embodiments, not intended to limit the present disclosure.

In the specification, a singular form may include a plural form unless mentioned in the context, and an expression “at least one (one or more) of A, B, and C” may include one or more of all combinations of A, B, and C.

In describing components of the exemplary embodiments of the present disclosure, the terms first, second, A, B, (a), (b), and the like may be used herein.

These terms are only used to distinguish one component from another component, but do not limit the corresponding components irrespective of the nature, order, or priority of the corresponding components.

Furthermore, when it is described that a component is ‘connected to”, ‘coupled to’, or ‘electrically connected to” a second component, the component may not only be directly connected to, coupled to, or electrically connected to the second component, but also be ‘connected to’, ‘coupled to’, or ‘electrically connected to’ the second component due to a third component therebetween.

Furthermore, when it is described that a component is formed or disposed “on an upper side of (above) or on a lower side of (under)” a second component, the two components may not only directly contact with each other but also a third component may be formed or disposed between the two components. Furthermore, the expression “on an upper side of (above) or on a lower side of (under)” may mean not only an upward direction but also a downward direction with respect to one component.

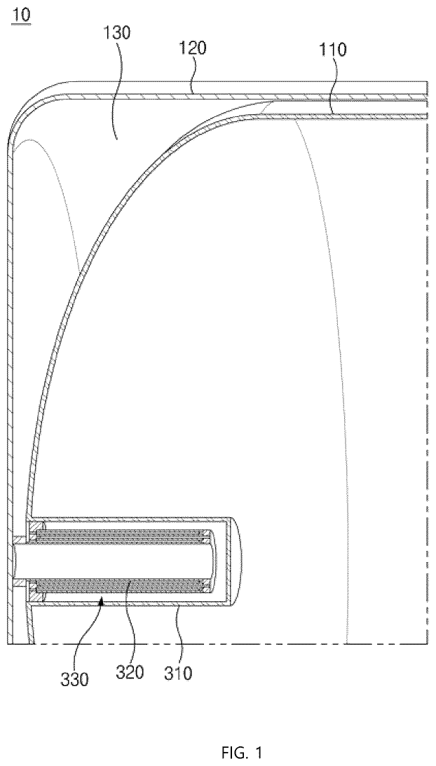

Referring to FIGS. 1 to 6, a cryogenic liquid storage apparatus 10 according to an exemplary embodiment of the present disclosure includes an internal container 110, in which a cryogenic liquid is accommodated, an external container 120 which surrounds a circumference of the internal container 110, an external suspension portion 320 that is connected to an internal surface of the external container 120, an internal suspension portion 310 which is connected to the internal container 110, and a connection suspension portion 330 which is continuously connecting the external suspension portion 320 and the internal suspension portion 310 and defines a transfer path of heat which is transferred from the external container 120 to the internal container 110.

For reference, the cryogenic liquid storage apparatus 10 according to an exemplary embodiment of the present disclosure may be used to store various objects according to required conditions and design specifications, and the present disclosure is neither limited nor restricted by the kind and features of the stored object.

As an exemplary embodiment of the present disclosure, the cryogenic liquid storage apparatus 10 according to an exemplary embodiment of the present disclosure may be used to store a fuel (for example, liquid hydrogen) which is used in a mobility, such as a fuel cell vehicle (for example, a car or a truck), to which a fuel cell system is applied, a ship, or an aircraft.

The cryogenic liquid storage apparatus 10 is configured to store hydrogen used in the fuel cell stack in a liquid state (liquid hydrogen which is a cryogenic liquid).

Hereinafter, only one storage container, in which the cryogenic liquid storage apparatus 10 includes an internal container 110 and an external container 120, will be described as an example. According to another exemplary embodiment of the present disclosure, the cryogenic liquid storage apparatus may include a plurality of storage containers that store a cryogenic liquid individually.

The storage container may be disposed in various structures, in which hydrogen may be stored in a liquid state (for example, −253° C. with respect to the atmospheric pressure), but the present disclosure is neither limited nor restricted by the kind and structure of the storage container.

Referring to FIG. 1, according to an exemplary embodiment of the present disclosure, the storage container may include the internal container 110 including an accommodation space, in which a cryogenic liquid is accommodated, and the external container 120 which is formed to surround a circumference of the internal container 110.

The structures and materials of the internal container 110 and the external container 120 that forms the storage container may be various according to required conditions and design specifications, and the present disclosure is neither limited or restricted by the structures and materials of the internal container 110 and the external container 120.

As an exemplary embodiment of the present disclosure, the internal container 110 may be formed of a general thermally conductive material (for example, a metal) having a thermal conductivity. According to another exemplary embodiment of the present disclosure, the internal container may be formed of a multi-layer insulation (MLI) material or other materials.

The cryogenic liquid storage apparatus 10 may include a vacuum insulation layer 130 which is defined between the internal container 110 and the external container 120.

In the present way, according to an exemplary embodiment of the present disclosure, by providing the vacuum insulation layer 130 that performs vacuum insulation between the internal container 110 and the external container 120, an insulation performance (a cryogenic insulation performance) may be sufficiently secured, and evaporation (vaporization) of liquid hydrogen due to introduction of heat may be minimized.

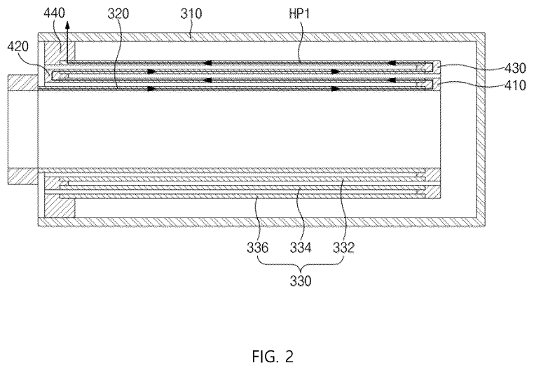

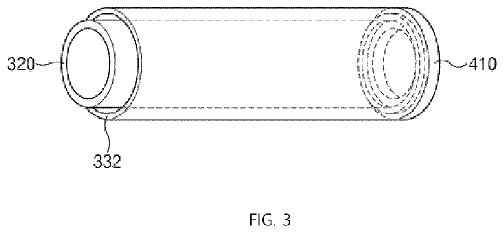

Referring to FIG. 1, FIG. 2, and FIG. 3, an external suspension portion 320 and an internal suspension portion 310 may be configured to support the internal container 110 against the external container 120 mutually cooperatively.

As an exemplary embodiment of the present disclosure, the external suspension portion 320 may be connected (for example, connected through welding) to an internal surface of the external container 120 along a longitudinal direction of the external container 120, and the internal suspension portion 310 may be connected to an end portion of the internal container 110 to correspond to the external suspension portion 320.

In the above-described and illustrated exemplary embodiment of the present disclosure, it is described as an example that the external suspension portion 320 is disposed at an end portion of the external container 120 in the longitudinal direction thereof, but according to another exemplary embodiment of the present disclosure, the external suspension portion may be disposed at a side end portion or other portions of the external container.

The external suspension portion 320 and the internal suspension portion 310 may have various structures according to required conditions and design specifications, and the present disclosure is neither limited nor restricted by the structures and forms of the external suspension portion 320 and the internal suspension portion 310.

According to an exemplary embodiment of the present disclosure, the internal suspension portion 310 may be configured to surround a circumference of the external suspension portion 320, one end portion (a left end portion with reference to FIG. 2) of the external suspension portion 320 may be supported by the external container 120, and an opposite end portion (a right end portion with reference to FIG. 2) may be disposed as a kind of cantilever structure which is disposed as a free end portion in an interior of the internal suspension portion 310.

As an exemplary embodiment of the present disclosure, the external suspension portion 320 may be configured to have a substantially hollow cylindrical shape including a circular cross section, and the internal suspension portion 310 may have a substantially hollow cylindrical shape including a circular cross section which is greater than that of the external suspension portion 320. According to another exemplary embodiment of the present disclosure, the external suspension portion 320 and the internal suspension portion 310 may have a rectangular cross section or other shape of cross sections.

The connection suspension portion 330 is configured to define a transfer path of the heat transferred from the external container 120 to the internal container 110 while structurally connecting the external suspension portion 320 and the internal suspension portion 310.

The connection suspension portion 330 is configured to define heat transfer paths HP1 and HP2 of the heat transferred from the external container 120 to the internal container 110 while continuously connecting the external suspension portion 320 and the internal suspension portion 310.

The connection suspension portion 330 may be disposed in various structures which may connect the external suspension portion 320 and the internal suspension portion 310, and the present disclosure is neither limited nor restricted by the structure and form of the connection suspension portion 330.

According to an exemplary embodiment of the present disclosure, the connection suspension portion 330 may include a first pipeline member 332 that has a cross-sectional area which is greater than that of the external suspension portion 320, one end portion (a right end portion with reference to FIG. 2) of which is connected to an opposite end portion (a right end portion with reference to FIG. 2) of the external suspension portion 320, and an opposite end portion (a left end portion with reference to FIG. 2) is connected to the internal suspension portion 310, and the transfer path HP1 of the heat transferred from the external container 120 to the internal container 110 may be continuously defined along the external suspension portion 320 and the first pipeline member 332.

As an exemplary embodiment of the present disclosure, the first pipeline member 332 may have a substantially hollow cylindrical shape including a circular cross section which is greater than that of the external suspension portion 320, and the first pipeline member 332 may be configured to surround a circumference of the external suspension portion 320 to be spaced apart from the external suspension portion 320.

A spacing interval between the first pipeline member 332 and the external suspension portion 320 may be various according to required conditions and design specifications, and the present disclosure is neither limited nor restricted by the spacing interval between the first pipeline member 332 and the external suspension portion 320. As an exemplary embodiment of the present disclosure, the spacing interval between the first pipeline member 332 and the external suspension portion 320 may be defined to be 4 mm or more so that the insulation member 500 is accommodated.

The connection structure of the external suspension portion 320 and the first pipeline member 332 may be variously changed according to required conditions and design specifications, and the present disclosure is neither limited nor restricted by the connection structure of the external suspension portion 320 and the first pipeline member 332.

According to an exemplary embodiment of the present disclosure, the cryogenic liquid storage apparatus 10 may include a first connection flange 410 which is disposed at an opposite end portion (a right end portion with reference to FIG. 2) of the external suspension portion 320 and supports one end portion (a right end portion with reference to FIG. 2) of the first pipeline member 332 against the external suspension portion 320.

The first connection flange 410 may be disposed in various structures which may connect the external suspension portion 320 and the first pipeline member 332, and the present disclosure is neither limited nor restricted by the structure and form of the first connection flange 410.

As an exemplary embodiment of the present disclosure, the first connection flange 410 may be formed to include a substantially hollow annular shape, the external suspension portion 320 may be accommodated at one end portion of the first connection flange 410 along a circumferential direction, the first pipeline member 332 may be accommodated at an opposite end portion of the first connection flange 410 along the circumferential direction, and a support boss that supports the external suspension portion 320 and the first pipeline member 332 so that they are spaced apart from each other may be disposed at a substantially center portion of the first connection flange 410.

Hereinafter, an example, in which the external suspension portion 320 and the first pipeline member 332 are integrally fixed to the first connection flange 410 through welding, will be described. According to another exemplary embodiment of the present disclosure, the external suspension portion and the first pipeline member may be connected (or coupled) to the first connection flange via a separate fastening member.

According to an exemplary embodiment of the present disclosure, the connection suspension portion 330 may further include a second pipeline member 334 that has a cross-sectional area which is greater than that of the first pipeline member 332, and one end portion of which is connected to the opposite end portion of the first pipeline member 332, and a third pipeline member 336 that has a cross-sectional area which is greater than that of the second pipeline member, one end portion of which is connected to an opposite end portion of the second pipeline member 334, and an opposite end portion of which is connected to the internal suspension portion 310, and the transfer path HP1 of the heat transferred from the external container 120 to the internal container 110 may be defined in a continuous zig-zag shape along the external suspension portion 320, the first pipeline member 332, the second pipeline member 334, and the third pipeline member 336.

As an exemplary embodiment of the present disclosure, the second pipeline member 334 may have a substantially hollow cylindrical shape having a circular cross section which is greater than that of the first pipeline member 332, and the second pipeline member 334 may be configured to surround a circumference of the first pipeline member 332 to be spaced apart from the first pipeline member 332.

A spacing interval between the first pipeline member 332 and the second pipeline member 334 may be variously changed according to required conditions and design specifications, and the present disclosure is neither limited nor restricted by the spacing interval between the first pipeline member 332 and the second pipeline member 334. As an exemplary embodiment of the present disclosure, the spacing interval between the first pipeline member 332 and the second pipeline member 334 may be defined to be 4 mm or more so that the insulation member 500 is accommodated.

As an exemplary embodiment of the present disclosure, the third pipeline member 336 may have a substantially hollow cylindrical shape having a circular cross section which is greater than that of the second pipeline member 334, and the third pipeline member 336 may be configured to surround a circumference of the second pipeline member 334 to be spaced apart from the second pipeline member 334.

A spacing interval between the second pipeline member 334 and the third pipeline member 336 may be variously changed according to required conditions and design specifications, and the present disclosure is neither limited nor restricted by the spacing interval between the second pipeline member 334 and the third pipeline member 336. As an exemplary embodiment of the present disclosure, the spacing interval between the second pipeline member 334 and the third pipeline member 336 may be defined to be 4 mm or more so that the insulation member 500 is accommodated.

The connection structure of the first pipeline member 332 and the second pipeline member 334, the connection structure of the second pipeline member 334 and the third pipeline member 336, and the connection structure of the third pipeline member 336 and the internal suspension portion 310 may be variously changed according to required conditions and design specifications, and the present disclosure is neither limited nor restricted by the connection structure of the first pipeline member 332 and the second pipeline member 334, the connection structure of the second pipeline member 334 and the third pipeline member 336, and the connection structure of the third pipeline member 336 and the internal suspension portion 310.

According to an exemplary embodiment of the present disclosure, the cryogenic liquid storage apparatus 10 may include a second connection flange 420 which is disposed at an opposite end portion (a left end portion with reference to FIG. 2) of the first pipeline member 332 and supports one end portion (a left end portion with reference to FIG. 2) of the second pipeline member 334 against the first pipeline member 332, a third connection flange 430 which is disposed at an opposite end portion (a right end portion with reference to FIG. 2) of the second pipeline member 334 and supports one end portion (a right end portion with reference to FIG. 2) of the third pipeline member 336 against the second pipeline member 334, and a fourth connection flange 440 which is disposed at an opposite end portion (a left end portion with reference to FIG. 2) of the third pipeline member 336 and connects the third pipeline member 336 and the internal suspension portion 310.

The second connection flange 420 may be disposed in various structures which may connect the first pipeline member 332 and the second pipeline member 334, and the present disclosure is neither limited nor restricted by the structure and form of the second connection flange 420.

As an exemplary embodiment of the present disclosure, the second connection flange 420 may be formed to have a substantially hollow annular shape, the first pipeline member 332 may be accommodated at one end portion of the second connection flange 420 along a circumferential direction, the second pipeline member 334 may be accommodated at an opposite end portion of the second connection flange 420 along the circumferential direction, and a support boss that supports the first pipeline member 332 and the second pipeline member 334 so that they are spaced apart from each other may be disposed at a substantially center portion of the second connection flange 420.

Hereinafter, an example, in which the first pipeline member 332 and the second pipeline member 334 are integrally fixed to the second connection flange 420 through welding, will be described. According to another exemplary embodiment of the present disclosure, the first pipeline member and the second pipeline member may be connected (or coupled) to the second connection flange via a separate fastening member.

The third connection flange 430 may be disposed in various structures which may connect the second pipeline member 334 and the third pipeline member 336, and the present disclosure is neither limited nor restricted by the structure and form of the third connection flange 430.

As an exemplary embodiment of the present disclosure, the third connection flange 430 may be formed to have a substantially hollow annular shape, the second pipeline member 334 may be accommodated at one end portion of the third connection flange 430 along a circumferential direction, the third pipeline member 336 may be accommodated at an opposite end portion of the third connection flange 430 along the circumferential direction, and a support boss that supports the second pipeline member 334 and the third pipeline member 336 so that they are spaced apart from each other may be disposed at a substantially center portion of the third connection flange 430.

Hereinafter, an example, in which the second pipeline member 334 and the third pipeline member 336 are integrally fixed to the third connection flange 430 through welding, will be described. According to another exemplary embodiment of the present disclosure, the second pipeline member and the third pipeline member may be connected (or coupled) to the third connection flange via a separate fastening member.

The fourth connection flange 440 may be disposed in various structures which may connect the third pipeline member 336 and the internal suspension portion 310, and the present disclosure is neither limited nor restricted by the structure and form of the fourth connection flange 440.

As an exemplary embodiment of the present disclosure, the fourth connection flange 440 may be formed to have a substantially hollow annular shape, the third pipeline member 336 may be accommodated at one end portion of the fourth connection flange 440 along a circumferential direction, and the internal suspension portion 310 may be accommodated on an external peripheral surface of the fourth connection flange 440.

Hereinafter, an example, in which the third pipeline member 336 and the internal suspension portion 310 are integrally fixed to the fourth connection flange 440 through welding, will be described. According to another exemplary embodiment of the present disclosure, the third pipeline member and the internal suspension portion may be connected (or coupled) to the fourth connection flange via a separate fastening member.

In the above-described and illustrated exemplary embodiment of the present disclosure, an example, in which the connection suspension portion 330 includes three pipeline members (the first pipeline member, the second pipeline member, and the third pipeline member), but according to another exemplary embodiment of the present disclosure, the connection suspension portion may include four or more pipeline members or to include two or less pipeline member.

Furthermore, in the above-described and illustrated exemplary embodiment of the present disclosure, an example, in which the first pipeline member 332, the second pipeline member 334, and the third pipeline member 336 that form the connection suspension portion 330 have a linear form, but according to another exemplary embodiment of the present disclosure, the first pipeline member, the second pipeline member, and the third pipeline member may have a curved form or other forms.

The sizes and materials of the first pipeline member 332, the second pipeline member 334, and the third pipeline member 336 that form the connection suspension portion 330 may be variously changed according to required conditions and design specifications, and the present disclosure is neither limited nor restricted by the sizes and materials of the first pipeline member 332, the second pipeline member 334, and the third pipeline member 336.

As an exemplary embodiment of the present disclosure, the first pipeline member 332, the second pipeline member 334, and the third pipeline member 336 may be formed of general stainless steel (for example, SUS304), the first pipeline member 332, the second pipeline member 334, and the third pipeline member 336 may have lengths of approximately 300 mm, and when the internal container 110 is 400 kg, the maximum stresses applied to the pipeline member may be defined not to exceed 205 mPa which is a yield strength of stainless steel (for example, SUS304).

In the above-described and illustrated example of the present disclosure, an example, in which the external suspension portion 320, the first pipeline member 332, the second pipeline member 334, and the third pipeline member 336 have the same thickness (cross-sectional area), is described, but according to another exemplary embodiment of the present disclosure, the external suspension portion 320, the first pipeline member 332, the second pipeline member 334, and the third pipeline member 336 may have different thicknesses (cross-sectional areas).

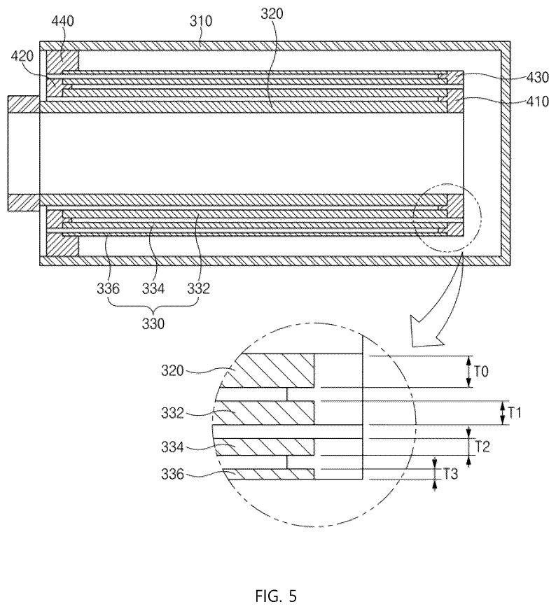

Referring to FIG. 5, according to an exemplary embodiment of the present disclosure, the first pipeline member 332 may have a thickness which is smaller than that of the external suspension portion 320, the second pipeline member 334 may have a thickness which is smaller than that of the first pipeline member 332, and the third pipeline member 336 may have a thickness which is smaller than that of the second pipeline member 334.

This is caused due to an aspect that an amount of heat which is introduced (conducted) along the pipeline members becomes smaller but the yield strength becomes higher as the thicknesses (cross-sectional areas) of the pipeline members become thinner, and according to an exemplary embodiment of the present disclosure, the heat transferred from the external container 120 to the internal container 110 along the connection suspension portion 330 may be minimized while the structural strength of the connection suspension portion 330 is secured as the thicknesses of the external suspension portion 320 (T0), the first pipeline member 332 (T1), the second pipeline member 334 (T2), and the third pipeline member 336 (T3) are sequentially smaller in their sequences (T0>T1>T2>T3).

As an exemplary embodiment of the present disclosure, a conventional SUS304-based standardized pipeline (for example, a tube 50) having a diameter of 60.5 mm and a thickness of 5.5 mm may be used as the external suspension portion 320, a conventional SUS304-based standardized pipeline (for example, a tube 65) having a diameter of 76.3 mm and a thickness of 3 mm may be used as the first pipeline member 332, a conventional SUS304-based standardized pipeline (for example, a tube 80) having a diameter of 89.1 mm and a thickness of 2.1 mm may be used as the second pipeline member 334, and a conventional SUS304-based standardized pipeline (for example, a tube 90) having a diameter of 101.6 mm and a thickness of 1.5 mm may be used as the third pipeline member 336.

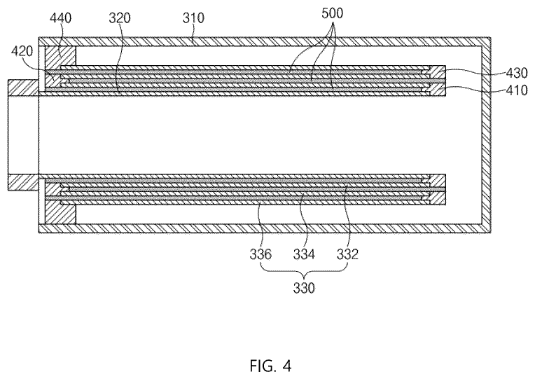

Referring to FIG. 4, according to an exemplary embodiment of the present disclosure, the cryogenic liquid storage apparatus 10 may include an insulation member 500 which is interposed at least one of between the external suspension portion 320 and the first pipeline member 332, between the first pipeline member 332 and the second pipeline member 334, and between the second pipeline member 334 and the third pipeline member 336.

Hereinafter, an example, in which the insulation members 500 are disposed between the external suspension portion 320 and the first pipeline member 332, between the first pipeline member 332 and the second pipeline member, and the second pipeline member 334 and the third pipeline member 336, respectively, will be described.

Various insulation materials which may minimize a transfer of heat between adjacent pipeline members (or external suspension parts) may be used as the insulation member 500, and the present disclosure is neither limited nor restricted by the kind and features of the insulation member.

As an exemplary embodiment of the present disclosure, a multi-layer insulation (MLI) material may be used for the insulation member 500.

In the present way, by providing the insulation members 500 between the external suspension portion 320 and the first pipeline member 332, between the first pipeline member 332 and the second pipeline member, and the second pipeline member 334 and the third pipeline member 336, transfer of heat between adjacent pipeline members (or external suspension parts) may be minimized, and thus, transfer of the heat of a relatively high temperature portion (for example, the external suspension part) to a low temperature portion (for example, the first pipeline member) disposed on a downstream side (a downstream side along a transfer direction of the heat) of the high temperature portion through a side surface of the high temperature portion may be minimized.

Meanwhile, in the above-described and illustrated exemplary embodiment of the present disclosure, an example, in which among the external suspension portion 320, the first pipeline member 332′, the second pipeline member 334′, and the third pipeline member 336′, the external suspension portion 320 which is connected to the external container 120 includes the largest thickness, but according to another exemplary embodiment of the present disclosure, the external suspension portion 320 connected to the external container 120 may have a relatively small thickness.

This is caused by an aspect that thermal conductivity becomes higher as it goes toward a high temperature portion in heat transfer, and the heat transferred from the external container 120 to the internal container 110 along the connection suspension portion 330′ may be reduced more when the high temperature portion (the external suspension part) connected to the external container 120 has a small thickness (cross-sectional area).

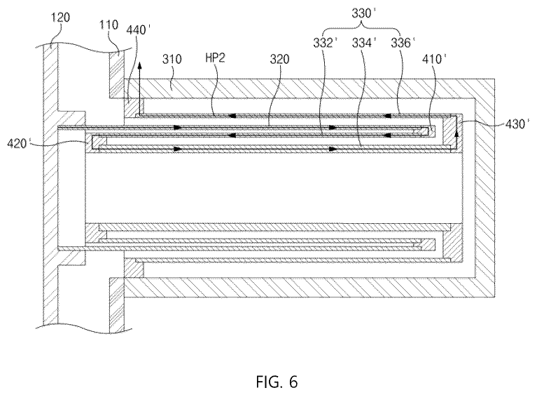

That is, referring to FIG. 6, the connection suspension portion 330′ may include a first pipeline member 332′ which is disposed in an interior of the external suspension portion 320 to have a cross-sectional area which is smaller than that of the external suspension portion 320, one end portion of which is connected to an opposite end portion of the external suspension portion 320, and an opposite end portion of which is connected to the internal suspension portion 310, a second pipeline member 334′ which is disposed in an interior of the first pipeline member 332′ to have a cross-sectional area which is smaller than that of the first pipeline member 332′, and one end portion of which is connected to an opposite end portion of the first pipeline member 332′, and a third pipeline member 336′ which is disposed between the external suspension portion 320 and the internal suspension portion 310 to include a cross-sectional area which is greater than that of the external suspension portion 320, and one end of which is connected to an opposite end portion of the second pipeline member 334′, and an opposite end portion of which is connected to the internal suspension portion 310, and the transfer path HP2 of the heat transferred from the external container 120 to the internal container 110 may be defined as a continuous zig-zag shape (for example, a substantially Z-shaped form) along the external suspension portion 320, the first pipeline member 332′, the second pipeline member 334′, and the third pipeline member 336′.

As an exemplary embodiment of the present disclosure, the first pipeline member 332′ may have a substantially hollow cylindrical shape including a circular cross section which is smaller than that of the external suspension portion 320, and the first pipeline member 332′ may be disposed in an interior of the external suspension portion 320 to be spaced apart from an internal surface of the external suspension portion 320.

A spacing interval between the first pipeline member 332′ and the external suspension portion 320 may be variously changed according to required conditions and design specifications, and the present disclosure is neither limited nor restricted by the spacing interval between the first pipeline member 332′ and the external suspension portion 320. As an exemplary embodiment of the present disclosure, the spacing interval between the first pipeline member 332′ and the external suspension portion 320 may be defined to be 4 mm or more so that the insulation member 500 is accommodated.

The connection structure of the external suspension portion 320 and the first pipeline member 332′ may be variously changed according to required conditions and design specifications, and the present disclosure is neither limited nor restricted by the connection structure of the external suspension portion 320 and the first pipeline member 332′.

According to an exemplary embodiment of the present disclosure, the cryogenic liquid storage apparatus 10 may include a first connection flange 410′ which is disposed at an opposite end portion (a right end portion with reference to FIG. 2) of the external suspension portion 320 and supports one end portion (a right end portion with reference to FIG. 2) of the first pipeline member 332′ against the external suspension portion 320.

The first connection flange 410′ may be disposed in various structures which may connect the external suspension portion 320 and the first pipeline member 332′, and the present disclosure is neither limited nor restricted by the structure and form of the first connection flange 410′.

Hereinafter, an example, in which the external suspension portion 320 and the first pipeline member 332′ are integrally fixed to the first connection flange 410′ through welding, will be described. According to another exemplary embodiment of the present disclosure, the external suspension portion and the first pipeline member may be connected (or coupled) to the first connection flange via a separate fastening member.

The second pipeline member 334′ may have a substantially hollow cylindrical shape including a circular cross section which is smaller than that of the first pipeline member 332′, and the second pipeline member 334′ may be disposed in an interior of the first pipeline member 332 to be spaced apart from an internal surface of the first pipeline member 332′.

A spacing interval between the first pipeline member 332′ and the second pipeline member 334′ may be variously changed according to required conditions and design specifications, and the present disclosure is neither limited nor restricted by the spacing interval between the first pipeline member 332′ and the second pipeline member 334′. As an exemplary embodiment of the present disclosure, the spacing interval between the first pipeline member 332′ and the second pipeline member 334′ may be defined to be 4 mm or more so that the insulation member 500 is accommodated.

The third pipeline member 336′ may be formed to have a substantially hollow cylindrical shape having a cross-sectional area which is greater than the external suspension portion 320 (a cross-sectional area which is greater than that of the external suspension portion 320 and smaller than that of the internal suspension portion 310), and the third pipeline member 336′ may be disposed between the external suspension portion 320 and the internal suspension portion 310 to surround a circumference of the external suspension portion 320 to be spaced apart from the external suspension portion 320.

A spacing interval between the external suspension portion 320 and the third pipeline member 336′ may be variously changed according to required conditions and design specifications, and the present disclosure is neither limited nor restricted by the spacing interval between the external suspension portion 320 and the third pipeline member 336′. As an exemplary embodiment of the present disclosure, the spacing interval between the external suspension portion 320 and the third pipeline member 336′ may be defined to be 4 mm or more so that the insulation member 500 is accommodated.

Furthermore, the connection structure of the first pipeline member 332′ and the second pipeline member 334′, the connection structure of the second pipeline member 334′ and the third pipeline member 336′, and the connection structure of the third pipeline member 336′ and the internal suspension portion 310 may be variously changed according to required conditions and design specifications, and the present disclosure is neither limited nor restricted by the connection structure of the first pipeline member 332′ and the second pipeline member 334′, the connection structure of the second pipeline member 334′ and the third pipeline member 336′, and the connection structure of the third pipeline member 336′ and the internal suspension portion 310.

According to an exemplary embodiment of the present disclosure, the cryogenic liquid storage apparatus 10 may include a second connection flange 420′ which is disposed at an opposite end portion (a left end portion with reference to FIG. 2) of the first pipeline member 332′ and supports one end portion (a left end portion with reference to FIG. 2) of the second pipeline member 334′ against the first pipeline member 332′, a third connection flange 430′ which is disposed at an opposite end portion (a right end portion with reference to FIG. 2) of the second pipeline member 334′ and supports one end portion (a right end portion with reference to FIG. 2) of the third pipeline member 336′ against the second pipeline member 334', and a fourth connection flange 440′ which is disposed at an opposite end portion (a left end portion with reference to FIG. 2) of the third pipeline member 336′ and connects the third pipeline member 336′ and the internal suspension portion 310.

The second connection flange 420′ may be disposed in various structures which may connect the first pipeline member 332′ and the second pipeline member 334′, and the present disclosure is neither limited nor restricted by the structure and form of the second connection flange 420′.

Hereinafter, an example, in which the first pipeline member 332′ and the second pipeline member 334′ are integrally fixed to the second connection flange 420′ through welding, will be described. According to another exemplary embodiment of the present disclosure, the first pipeline member and the second pipeline member may be connected (or coupled) to the second connection flange via a separate fastening member.

The third connection flange 430′ may be disposed in various structures which may connect the second pipeline member 334′ and the third pipeline member 336′, and the present disclosure is neither limited nor restricted by the structure and form of the third connection flange 430′.

Hereinafter, an example, in which the second pipeline member 334′ and the third pipeline member 336′ are integrally fixed to the third connection flange 430′ through welding, will be described. According to another exemplary embodiment of the present disclosure, the second pipeline member and the third pipeline member may be connected (or coupled) to the third connection flange via a separate fastening member.

The fourth connection flange 440′ may be disposed in various structures which may connect the third pipeline member 336′ and the internal suspension portion 310, and the present disclosure is neither limited nor restricted by the structure and form of the fourth connection flange 440′.

Hereinafter, an example, in which the third pipeline member 336′ and the internal suspension portion 310′ are integrally fixed to the fourth connection flange 440′ through welding, will be described. According to another exemplary embodiment of the present disclosure, the third pipeline member and the internal suspension portion may be connected (or coupled) to the fourth connection flange via a separate fastening member.

In the above-described and illustrated exemplary embodiment of the present disclosure, an example, in which the connection suspension portion 330′ includes three pipeline members (the first pipeline member, the second pipeline member, and the third pipeline member), but according to another exemplary embodiment of the present disclosure, the connection suspension portion may include four or more pipeline members or to include two or less pipeline member.

Furthermore, in the above-described and illustrated exemplary embodiment of the present disclosure, an example, in which the first pipeline member 332′, the second pipeline member 334′, and the third pipeline member 336′ that form the connection suspension portion 330′ have a linear form, but according to another exemplary embodiment of the present disclosure, the first pipeline member, the second pipeline member, and the third pipeline member may have a curved form or other forms.

The sizes and materials of the first pipeline member 332′, the second pipeline member 334′, and the third pipeline member 336′ that form the connection suspension portion 330′ may be variously changed according to required conditions and design specifications, and the present disclosure is neither limited nor restricted by the sizes and materials of the first pipeline member 332′, the second pipeline member 334′, and the third pipeline member 336′.

As an exemplary embodiment of the present disclosure, the first pipeline member 332′, the second pipeline member 334′, and the third pipeline member 336′ may be formed of general stainless steel (for example, SUS304), the first pipeline member 332′, the second pipeline member 334′, and the third pipeline member 336′ may have lengths of approximately 300 mm, and when the internal container 110 is 400 kg, the maximum stresses applied to the pipeline member may be defined not to exceed 205 mPa which is a yield strength of stainless steel (for example, SUS304).

Thicknesses of the first pipeline member 332′, the second pipeline member 334′, and the third pipeline member 336′ may be variously changed according to required conditions and design specifications, and the present disclosure is neither limited nor restricted by the thicknesses of the first pipeline member 332′, the second pipeline member 334′, and the third pipeline member 336′.

Referring to FIG. 6, according to an exemplary embodiment of the present disclosure, the first pipeline member 332′ may have a thickness which is greater than that of the external suspension portion 320′, the second pipeline member 334′ may have a thickness which is greater than that of the first pipeline member 332′, and the third pipeline member 336′ may have a thickness which is smaller than that of the second pipeline member 334′ (a thickness which is smaller than that of the external suspension portion 320).

As an exemplary embodiment of the present disclosure, a conventional SUS304-based standardized pipeline (for example, a tube 80) having a diameter of 89.1 mm and a thickness of 2.1 mm may be used as the external suspension part 320′, a conventional SUS304-based standardized pipeline (for example, a tube 65) having a diameter of 76.3 mm and a thickness of 3 mm may be used as the first pipeline member 332′, a conventional SUS304-based standardized pipeline (for example, a tube 50) having a diameter of 60.5 mm and a thickness of 5.5 mm may be used as the second pipeline member 334′, and a conventional SUS304-based standardized pipeline (for example, a tube 90) having a diameter of 101.6 mm and a thickness of 1.5 mm may be used as the third pipeline member 336′.

Furthermore, as in the above-described embodiment, the insulation member (see 500 of FIG. 4) may be disposed at least any one of between the external suspension portion 320 and the first pipeline member 332', between the first pipeline member 332′ and the second pipeline member 334′, and between the second pipeline member 334′ and the third pipeline member 336′.

As described above, according to an exemplary embodiment of the present disclosure, the insulation performance may be secured and the safety and reliability may be improved.

According to an exemplary embodiment of the present disclosure, heat which is conducted to an internal container (storage container) via a suspension portion that supports the internal container against an external container may be minimized and an insulation performance of the internal container may be secured.

Most of all, according to an exemplary embodiment of the present disclosure, the heat transferred (conducted) from the external container to the internal container may be minimized by sufficiently securing the transfer path of the heat transferred along the suspension portion while securing the structural stability by the suspension portion.

Furthermore, according to an exemplary embodiment of the present disclosure, loss (an amount of discharged hydrogen) of hydrogen may be minimized while durability and safety are secured, and a time point, at which the hydrogen starts to be lost, may be maximally delayed (a non-loss hydrogen keeping period is extended).

Furthermore, according to an exemplary embodiment of the present disclosure, an excessive pressure rise (expansion) of the storage container may be restrained, and safety and reliability may be improved.

Although the exemplary embodiments have been mainly described above, they are simply examples and are not intended to limit the present disclosure, and it may be understood by those skilled in the art, to which the present disclosure pertains, that various modifications and applications that have not been described above may be possible while departing from essential characteristics of the embodiment. For example, the components that appear in detail in the exemplary embodiment of the present disclosure may be conducted after being modified. Furthermore, it should be construed that the differences related to the modifications and applications are included in the scope of the present disclosure, which is defined in the attached claims.

What is claimed is:

1. A cryogenic liquid storage apparatus comprising:
an internal container, in which a cryogenic liquid is accommodated;
an external container surrounding a circumference of the internal container;
an external suspension portion connected to an internal surface of the external container;
an internal suspension portion connected to the internal container; and
a connection suspension portion continuously connecting the external suspension portion and the internal suspension portion and defining a transfer path of heat transferred from the external container to the internal container.

2. The cryogenic liquid storage apparatus of claim 1,
wherein the internal suspension portion surrounds a circumference of the external suspension portion, and
wherein one end portion of the external suspension portion is supported by the external container, and an opposite end portion of the external suspension portion is disposed as a free end portion in an interior of the internal suspension portion.

3. The cryogenic liquid storage apparatus of claim 2,
wherein the connection suspension portion comprises at least one pipeline member, one end portion of which is connected to the opposite end portion of the external suspension portion, and an opposite end portion of which is connected to the internal suspension portion, and
wherein the transfer path of the heat is continuously defined along the external suspension portion and the at least one pipeline member.

4. The cryogenic liquid storage apparatus of claim 3,
wherein the at least one pipeline member comprises a first pipeline member having a cross-sectional area being greater than a cross-sectional area of the external suspension portion, one end portion of which is connected to the opposite end portion of the external suspension portion, and an opposite end portion of which is connected to the internal suspension portion, and
wherein the transfer path of the heat is continuously defined along the external suspension portion and the first pipeline member.

5. The cryogenic liquid storage apparatus of claim 4, further comprising:
a first connection flange disposed at the opposite end portion of the external suspension portion, and supporting the one end portion of the first pipeline member against the external suspension portion.

6. The cryogenic liquid storage apparatus of claim 4, wherein the first pipeline member has a thickness being smaller than a thickness of the external suspension portion.

7. The cryogenic liquid storage apparatus of claim 4, wherein the at least one pipeline member further comprises:
a second pipeline member having a cross-sectional area being greater than the cross-sectional area of the first pipeline member, and one end portion of which is connected to the opposite end portion of the first pipeline member; and
a third pipeline member including a cross-sectional area being greater than the cross-sectional area of the second pipeline member, one end portion of which is connected to an opposite end portion of the second pipeline member, and an opposite end portion of which is connected to the internal suspension portion, and
wherein the transfer path of the heat is defined in a continuous zig-zag shape along the external suspension portion, the first pipeline member, the second pipeline member, and the third pipeline member.

8. The cryogenic liquid storage apparatus of claim 7, further comprising:
a second connection flange disposed at the opposite end portion of the first pipeline member, and supporting the one end portion of the second pipeline member against the first pipeline member;
a third connection flange disposed at the opposite end portion of the second pipeline member, and supporting the one end portion of the third pipeline member against the second pipeline member; and
a fourth connection flange disposed at the opposite end portion of the third pipeline member, and connecting the third pipeline member and the internal suspension portion.

9. The cryogenic liquid storage apparatus of claim 7,
wherein the second pipeline member has a thickness being smaller than a thickness of the first pipeline member, and
wherein the third pipeline member has a thickness being smaller than the thickness of the second pipeline member.

10. The cryogenic liquid storage apparatus of claim 7, comprising:
an insulation member interposed between the external suspension portion and the first pipeline member, between the first pipeline member and the second pipeline member, or between the second pipeline member and the third pipeline member.

11. The cryogenic liquid storage apparatus of claim 3, wherein the at least one pipeline member comprises:
a first pipeline member disposed in an interior of the external suspension portion to have a cross-sectional area being smaller than a cross-sectional area of the external suspension portion, one end portion of which is connected to the opposite end portion of the external suspension portion, and an opposite end portion of which is connected to the internal suspension portion, and
wherein the transfer path of the heat is continuously defined along the external suspension portion and the first pipeline member.

12. The cryogenic liquid storage apparatus of claim 11, further comprising:
a first connection flange disposed at the opposite end portion of the external suspension portion, and supporting the one end portion of the first pipeline member against the external suspension portion.

13. The cryogenic liquid storage apparatus of claim 11, wherein the first pipeline member has a thickness being greater than a thickness of the external suspension portion.

14. The cryogenic liquid storage apparatus of claim 11, wherein the at least one pipeline member further comprises:
a second pipeline member disposed in an interior of the first pipeline member to have a cross-sectional area being smaller than the cross-sectional area of the first pipeline member, and one end portion of which is connected to the opposite end portion of the first pipeline member; and
a third pipeline member disposed between the external suspension portion and the internal suspension portion to have a cross-sectional area being greater than the cross-sectional area of the external suspension portion, one end portion of which is connected to an opposite end portion of the second pipeline member, and an opposite end portion of which is connected to the internal suspension portion, and
wherein the transfer path of the heat is defined in a continuous zig-zag shape along the external suspension portion, the first pipeline member, the second pipeline member, and the third pipeline member.

15. The cryogenic liquid storage apparatus of claim 14, further comprising:
a second connection flange disposed at the opposite end portion of the first pipeline member, and supporting the one end portion of the second pipeline member against the first pipeline member;
a third connection flange disposed at the opposite end portion of the second pipeline member, and supporting the one end portion of the third pipeline member against the second pipeline member; and
a fourth connection flange disposed at the opposite end portion of the third pipeline member, and connecting the third pipeline member and the internal suspension portion.

16. The cryogenic liquid storage apparatus of claim 14, wherein the second pipeline member and the third pipeline member have thicknesses being the same as or different from a thickness of the first pipeline member.

17. The cryogenic liquid storage apparatus of claim 14, wherein an insulation member interposed between the external suspension portion and the first pipeline member, between the first pipeline member and the second pipeline member, or between the second pipeline member and the third pipeline member.

18. A vehicle comprising the cryogenic liquid storage apparatus of claim 1.
